(19) United States
(12) Patent Application Publication
(10) Pub. No.: US 2009/0266651 A1
(43) Pub. Date: Oct. 29, 2009

(54) METHOD AND SYSTEM FOR INSTALLING THE GUIDE RAILS OF AN ELEVATOR AND USE OF THE SYSTEM IN INSTALLING THE GUIDE RAILS OF AN ELEVATOR

(75) Inventors: Gert VAN DER MEIJDEN, Otterlo (NL); Jos VAN DEN HEUVEL, 'S-Hertogenbosch (NL)

Correspondence Address: BIRCH STEWART KOLASCH & BIRCH, PO BOX 747, FALLS CHURCH, VA, 22040-0747, US

(73) Assignee: KONE CORPORATION, Helsinki (FI)

(21) Appl. No.: 12/434,301

(22) Filed: May 1, 2009

Related U.S. Application Data
(63) Continuation of application No. PCT/FI2007/000254, filed on Oct. 22, 2007.

(30) Foreign Application Priority Data
Nov. 2, 2006 (FI) 20060963

(51) Int. Cl. B66B 7/02; B66B 11/00

(52) U.S. Cl. 187/408; 52/741.1

(57) ABSTRACT

Method and system for installing guide rails (1), such as the car guide rails and/or the counterweight guide rails, on the vertical wall (3) of the elevator shaft (2) of a building, in which method the guide rail (1) is installed by assembly in phases from the bottom upwards by placing guide rail sections (4¹, 4², 4³, 4⁴ . . . ) that are shorter than the whole length of the guide rail one on top of the other, and by fixing the guide rail sections to the vertical wall (3) with guide rail fixings (5). The alignment of each lower guide rail section that is already installed and fixed is used as a comparison point for the alignment of the next upper guide rail section to be installed above it, such that each upper guide rail section is installed in alignment with each consecutive lower guide rail section that is already installed. The system likewise comprises means for using the alignment of each lower guide rail section that is already installed and fixed as a comparison point for the alignment of the next upper guide rail section to be installed above it, such that each upper guide rail section is installed in alignment with each consecutive lower guide rail section that is already installed. The system is used preferably in installing the guide rails of a tower building. Similarly, its use is advantageous in installing guide rails with the jump lift technique.

### FIELD OF THE INVENTION

The present invention relates to a method as defined in the preamble of claim 1. The present invention also relates to a system as defined in the preamble of claim 9. The present invention further relates to the use as defined in the preamble of claim 14. The present invention further relates to the use as defined in the preamble of claim 15.

### BACKGROUND OF THE INVENTION

A prior art method for installing the guide rails, such as the car guide rails and/or the counterweight guide rails, of an elevator on the vertical wall of an elevator shaft of a building. In a prior-art method the guide rail is installed by assembly in phases from the bottom upwards by placing guide rail sections that are shorter than the whole length of the guide rail one on top of the other, and by fixing the guide rail sections to the vertical wall with guide rail fixings. Previously the guide rail sections have been aligned with plumb lines suspended in the elevator shaft or with a laser forming a perpendicular laser light beam, in which case the guide rail sections are installed to be perpendicular. When installing guide rails in high-rise tower buildings problems arise from this kind of installation method because the upper part of the building and, of course, at the same time the vertical wall of the elevator shaft along with it, can move under the effect of the heat of the sun, when one side of the building heats up. Likewise the wind load can move the building. Thus when the building and the elevator shaft bend, the plumb line or the laser light beam remains perpendicular. If the guide rails are installed perpendicularly when the building is bent, they are no longer perpendicular when the building straightens. For this reason it is necessary to wait for suitable weather conditions when installing the guide rails, which lengthens the time needed for installation and incurs great costs.

When using plumb lines in tower buildings, the airflow in the elevator shaft, which moves the plumb lines, is always a problem.

In the so-called jump lift installation of the guide rails of an elevator, the guide rails are installed using the elevator as an aid and the roping of the elevator car is moved upwards in jumps of one or more floors of the building. For example, the installation of the guide rails of a 40-storey tower building with the jump lift techniques requires 16 jump phases. In prior art the straightness and perpendicularity of the guide rails is verified with plumb lines from every other floor downwards to the existing guide rails, which is very awkward and time-consuming.

### PURPOSE OF THE INVENTION

The purpose of the invention is to eliminate the aforementioned drawbacks.

More particularly, a purpose of the invention is to disclose a method and a system, by means of which the installation of the guide rails can take place quickly and independently of the weather conditions.

A further purpose of the invention is to disclose a suitable method and system for installing the guide rails of an elevator of, more particularly, a tower building.

Another purpose of the invention is to disclose an installation method and a system for the guide rails of an elevator that is applicable to the so-called jump lift technique.

### SUMMARY OF THE INVENTION

The method according to the invention is characterized by what is disclosed in the characterization part of claim 1. The system according to the invention is characterized by what is disclosed in the characterization part of claim 9. The uses according to the invention are characterized by what is disclosed in the characterization parts of claims 14 and 15. Other embodiments of the invention are characterized by what is disclosed in the other claims. Some inventive embodiments are also discussed in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments can be applied within the scope of the basic inventive concept in conjunction with other embodiments.

In the method according to the invention the alignment of each lower guide rail section that is already installed and fixed to the vertical wall is used as a comparison point for the alignment of the next upper guide rail section to be installed above it, such that each upper guide rail section is installed in alignment with each consecutive lower guide rail section.

The system according to the invention comprises means for using the alignment of each lower guide rail section that is already installed and fixed to the vertical wall as a comparison point for the alignment of the next upper guide rail section to be installed above it, such that each upper guide rail section is installed in alignment with each consecutive lower guide rail section that is already installed.

One advantage of the invention is that the guide rails can be installed in a tower building irrespective of the external weather conditions, such as the wind and/or the heat of the sun, although the building could be bent, which increases the efficiency of installation and reduces the time it requires. With the method according to the invention it is possible to have each guide rail section on the same line as the previous guide rail section that is already installed. When the existing lower guide rail section can be used as a reference for the upper guide rail section, the alignment can be performed from the bottom upwards. This saves a substantial amount of installation time also in connection with the jump lift technique, in which it is possible to save 3-5 hours in each jump phase. In the example case of the 40-storey tower building presented above, 16 times 3-5 hours of installation time is saved.

In one embodiment of the method the guide rail sections are aligned by means of the laser light beam produced by a laser. Since plumb lines are not used in the method, the airflow in the elevator shaft does not affect the alignment accuracy and the installation accuracy of the guide rail.

In one embodiment of the method the lowermost guide rail section, which must be installed first, of the guide rail is aligned and installed to be perpendicular by means of a plumb line and/or a perpendicularly aimed laser light beam.

In one embodiment of the method two alignment appliances, a lower alignment appliance and an upper alignment appliance, are fixed in a detachable manner to the lower guide rail section that is already installed and aligned at a distance from each other in the height direction. In both the alignment appliances is an alignment aperture, which when fixing the alignment appliance to the guide rail section settles in the lateral direction a pre-defined fixed distance from the guide rail section. A laser is fixed in a detachable manner in the proximity of the lower guide rail section at a distance below the lower alignment appliance. The laser light beam of the laser is directed through the alignment apertures of the lower alignment appliance and the upper alignment appliance, in which case the laser light beam settles in alignment with the lower guide rail. A targeting appliance, which contains a targeting element, which when fixing the targeting appliance to the guide rail section settles in the transverse direction of the guide rail the aforementioned pre-defined fixed distance from the guide rail section, is fixed in a detachable manner in the proximity of at least one guide rail fixing of the upper guide rail section to be next installed. The upper guide rail section to be installed is moved in the lateral direction such that the laser light beam hits the targeting element of the targeting appliance, in which position the upper guide rail is held in place, and the upper guide rail is fixed to the guide rail fixing.

In one embodiment of the method at least one alignment appliance is fixed in a detachable manner to the lower guide rail section that is already installed and aligned, which alignment appliance contains an alignment aperture, which when fixing the alignment appliance to the guide rail section settles in the lateral direction a pre-defined fixed distance from the guide rail section. A laser, which settles in the lateral direction a pre-defined fixed distance from the guide rail section, is fixed in a detachable manner to the lower guide rail section at a distance below the alignment appliance. The laser light beam of the laser is directed through the alignment aperture of the alignment appliance, in which case the laser light beam settles in alignment with the lower guide rail. A targeting appliance, which contains a targeting element, which when fixing the targeting appliance to the guide rail section settles in the transverse direction of the guide rail the aforementioned pre-defined fixed distance from the guide rail section, is fixed in a detachable manner in the proximity of at least one guide rail fixing of the upper guide rail section to be next installed. The upper guide rail section to be installed is moved in the lateral direction such that the laser light beam hits the targeting element of the targeting appliance, in which position the upper guide rail is held in place and is fixed to the guide rail fixing of the upper guide rail section.

In one embodiment of the method during the alignment the targeting appliance is moved upwards in phases and the targeting appliance is fixed in two or more points one above the other along the length of the upper guide rail section, preferably in the proximity of two or more guide rail fixings that fix the guide rail section to the vertical wall.

In one embodiment of the method a laser light beam, the diameter of which is greater than the diameter of the alignment aperture, is directed at the alignment appliance, in which case the alignment aperture narrows the laser light beam.

In one embodiment of the method the diameter of the laser light beam is narrowed with the alignment aperture to approx. 1 mm.

In one embodiment of the system the means comprise a laser, which produces a laser light beam for aligning the guide rail section. The means further comprise a support element for supporting the laser on the vertical wall and/or on the guide rail section and/or on the guide rail fixing. The means further comprise at least one, preferably two, of the kind of alignment appliances that incorporate a first fixing element, such as a permanent magnet, for fixing the guide rail section, a first detent for positioning the alignment appliance into a precise position with respect to the guide rail section, and an alignment aperture, the diameter of which is at least as great and preferably smaller than the diameter of the laser light beam and which is at a distance from the first detent. In addition the means comprise a targeting appliance, which incorporates a second fixing element, such as a permanent magnet, for fixing the guide rail section, a second detent for positioning the targeting appliance into a precise position with respect to the guide rail section, and a targeting element, which is at a distance from the second detent and at which the laser light beam can be targeted.

In one embodiment of the system the diameter of the laser light beam produced by the laser is in the order of magnitude of approx. 3 mm.

In one embodiment of the system the alignment aperture is conical in shape such that the wall of the alignment aperture widens from the input side of the laser light beam towards the exit side at an angle, which is approx. 45°.

In one embodiment of the system the alignment aperture has a diameter on the input side in the order of magnitude of approx. 1 mm.

The system is very practicable in the installation of the guide rails of an elevator in the elevator shaft of a tower building. Likewise it is advantageous in the so-called jump lift installation of the guide rails of an elevator, in which the guide rail sections are installed using the elevator as an aid and the roping of the elevator car is moved upwards in jumps of one or more floors of the building.

### LIST OF FIGURES

In the following, the invention will be described in detail by the aid of a few examples of its embodiments with reference to the attached drawings, wherein

FIGS. 1-5 diagrammatically present the elevator shaft of a high-rise building, in which the guide rail is installed according to one embodiment of the method according to the invention,

FIG. 6 presents a magnified view of a part of the guide rail of FIGS. 1-5,

FIG. 7 presents a VII-VII section of FIG. 6,

FIG. 8 presents a laser viewed as a VIII-VIII section of FIG. 7,

FIG. 9 presents a lower alignment appliance viewed as a IX-IX section of FIG. 6,

FIG. 10 presents the alignment aperture of the lower alignment appliance as a X-X section of FIG. 9,

FIG. 11 presents an upper alignment appliance viewed as a XI-XI section of FIG. 6,

FIG. 12 presents the alignment aperture of the upper alignment appliance as a XII-XII section of FIG. 11,

FIG. 13 presents a targeting appliance as an XIII-XIII section of FIG. 6, and

FIG. 14 presents a XIV-XIV section of FIG. 13.

### DETAILED DESCRIPTION OF THE INVENTION

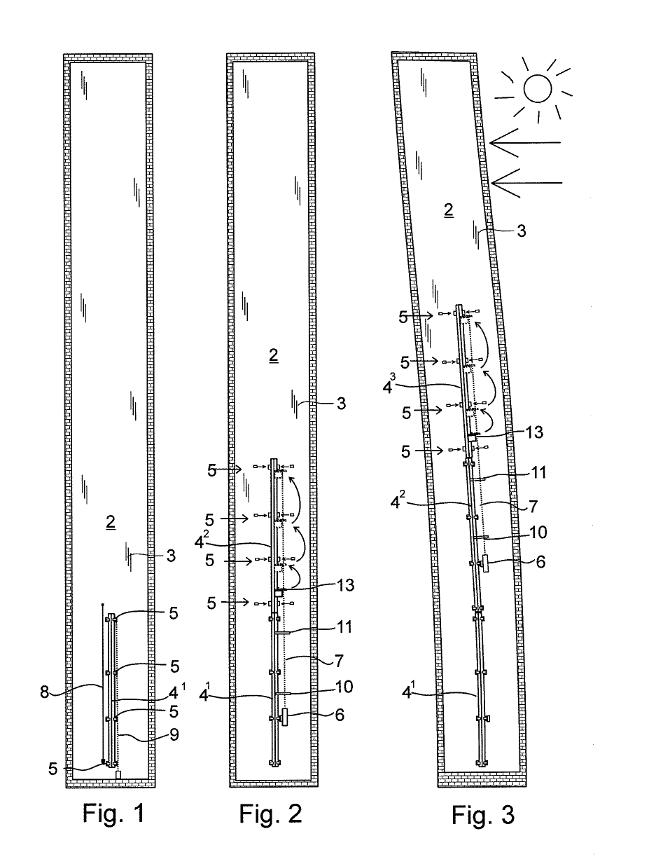

FIGS. 1-5 diagrammatically illustrate the principle of the installation method with a cross-section of the elevator shaft 2 of the tower building, onto the vertical wall 3 of which the guide rail 1 is installed by assembly in phases from the bottom upwards by placing guide rail sections 4¹, 4², 4³, 4⁴ . . . that are shorter than the whole length of the guide rail one on top of the other, and by fixing the guide rail sections to the vertical wall 3 with guide rail fixings 5. The dimensioning scales of the figures do not correspond to reality and they are selected primarily for illustrative purposes.

In FIG. 1 the lowermost guide rail section 4¹, which must be installed first, of the guide rail 1 is aligned and installed to be perpendicular by means of a plumb line 8 and/or a perpendicularly aimed laser light beam 9.

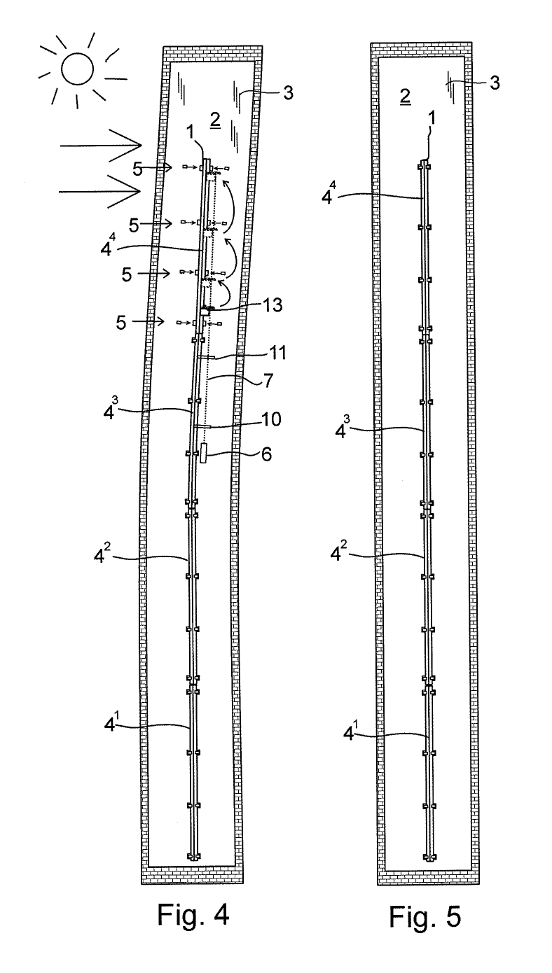

Then when installing the other guide rail sections 4², 4³, 4⁴ . . . the alignment of each lower guide rail section that is already installed and fixed to the vertical wall is used as a comparison point for the alignment of the next upper guide rail section to be installed above it, such that each upper guide rail section is installed in alignment with each consecutive lower guide rail section. FIG. 2 presents how the alignment of the first lowermost guide rail section 4¹ is used to determine the alignment of the next second guide rail section 4². Further, FIG. 3 presents how the alignment of the second guide rail section 4² is used to determine the alignment of the third guide rail section 4³. Also, FIG. 4 presents how the alignment of the third guide rail section 4³ is used to determine the alignment of the fourth guide rail section 4⁴.

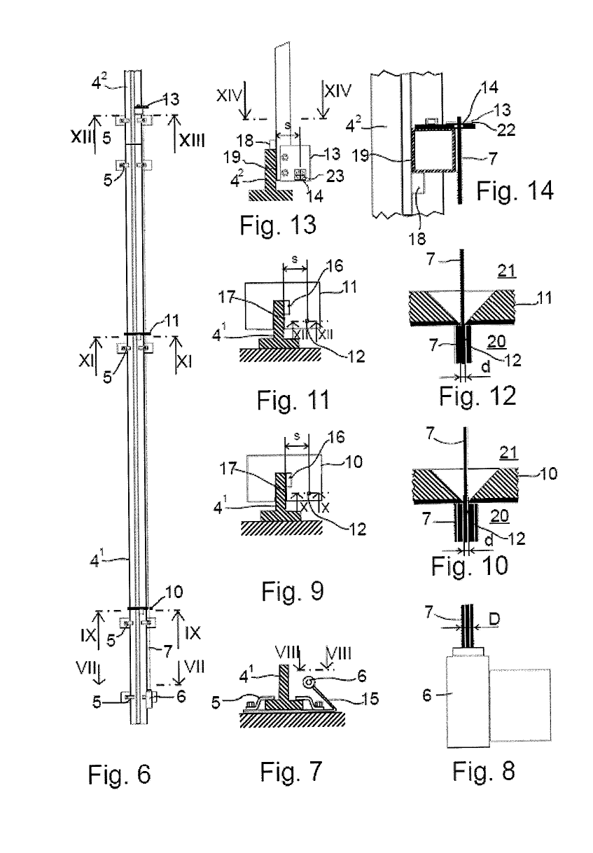

Referring now to FIGS. 2 and 6, the alignment takes place by means of the laser light beam 7 produced by the laser 6. Two alignment appliances 10, 11, which are a lower alignment appliance 10 and an upper alignment appliance 11, are fixed in a detachable manner to the lowermost guide rail section that is already installed and aligned at a distance from each other in the height direction. Each alignment appliance 10 and 11 incorporates an alignment aperture 12 (see FIGS. 9-12). When fixing the alignment appliance 10, 11 to the guide rail section the alignment aperture 12 settles in the lateral direction a pre-defined fixed distance s from the guide rail section. Then a laser 6 is fixed to a support element 15 in the proximity of the lowermost guide rail section 4¹ at a distance below the lower alignment appliance 10 (see FIG. 7). The laser 6 is preferably installed such that the elevator car can be driven past the laser 6 without touching it. The fixing of the laser 6 can, of course, be detached because the same laser is moved upwards and always fixed to each guide rail section. The laser light beam 7 of the laser 6 is directed through the alignment apertures 12 of the lower alignment appliance 10 and the upper alignment appliance 11, in which case the laser light beam 7 settles in alignment with the lowermost guide rail 4¹. A targeting appliance 13, which contains a targeting element 14 (such as aiming gridlines 23 in a transparent plate, see FIGS. 13 and 14), is fixed in a detachable manner in the proximity of at least one guide rail fixing 5 of the upper, i.e. the second, guide rail section 4² to be next installed. When fixing the targeting appliance 13 to the guide rail section the targeting element 14 settles in the lateral direction the same pre-defined fixed distance s from the guide rail section 4² as the alignment apertures 12. The position of the second upper guide rail section 4² is adjusted in the lateral direction such that the laser light beam 7 hits the targeting element 14 of the targeting appliance 13, is held in place in this position and is fixed to the guide rail fixing 5. The targeting appliance 13 can, as the alignment progresses, be moved upwards in phases such that the targeting appliance is fixed at two or more different points one above the other along the length of the upper guide rail section 4², preferably in the proximity of two or more guide rail fixings that fix the guide rail section to the vertical wall. FIG. 2 shows by way of an example that the targeting appliance 13 would be fixed to four different points, i.e. in the proximity of each guide rail fixing.

Referring now to FIGS. 8-12, the diameter D of the laser light beam 7 when it leaves the laser 6 is approx. 3 mm. When it hits the alignment appliance 10 the laser light beam has spread to some extent. The spreading is a result of the air in the elevator shaft and of the particles in the air, which cause dispersion in the laser light beam. In the alignment aperture 12, the diameter of which is approx. 1 mm, of the lower alignment appliance 10 the laser light beam 7 narrows correspondingly. The upper alignment 11 appliance is similar to the lower alignment appliance 10. In it also a laser light beam that has spread to some extent narrows again such that its diameter is approx. 1 mm. Thus a distinct light spot, by means of which the alignment can be performed, is achieved on the targeting element 14 of the targeting appliance 13 from the laser light beam 7.

FIG. 3 illustrates the third guide rail section 4³ in a situation in which the building and the elevator shaft have bent from the effect of the heat of the sun and of the wind. In this case the second guide rail section 4² that is already installed and already fixed to the vertical wall 3 of the elevator shaft 2 has bent along with the building and the vertical wall 3 of the elevator shaft 2, in which case the alignment of the second guide rail section 4² is at an angle with respect to the perpendicular. Despite this, the third guide rail section 4³ can be installed when the lower second guide rail section 4² is used as the comparison point of the alignment, in which case the third guide rail section becomes installed in the correct direction with respect to the elevator shaft. The installation and alignment of the third guide rail section 4³ with respect to the second guide rail section 4² occurs using the same principle as the installation and alignment of the second guide rail section 4² with respect to the first guide rail section 4¹ as explained above in conjunction with FIG. 2.

FIG. 4 illustrates the installation and alignment of yet a fourth guide rail section 4⁴, when the heat of the sun and the wind exert an effect on the building from the opposite direction than in FIG. 3. The installation and alignment of the fourth guide rail section 4⁴ with the aid of the alignment of the third guide rail section 4³ also occurs using the same principle as the installation and alignment of the second guide rail section 4² with the aid of the alignment of the first guide rail section 41 as explained above in conjunction with FIG. 2.

FIG. 5 illustrates that when the building has straightened such that the elevator shaft 2 is perpendicular, the guide rail 1 assembled from the guide rail sections 4¹, 4², 4³, 4⁴ is also perpendicular.

Referring again to FIGS. 9 and 11, each alignment appliance 10, 11 comprises a first fixing element 16, such as a permanent magnet, by means of which the alignment appliance is fixed to the guide rail section 4¹, 4², 4³, 4⁴ . . . , and a first detent 17 for positioning the alignment appliance 10, 11 into a precise position with respect to the guide rail section. The diameter d of the alignment aperture 12 is preferably smaller than the diameter D of the laser light beam and is at the distance s from the first detent 17.

Referring now to FIGS. 13 and 14, the targeting appliance 13 incorporates a second fixing element 18, such as a permanent magnet, for fixing the guide rail section 4², 4³, 4⁴ . . . and a second detent 19 for positioning the targeting appliance into a precise position with respect to the guide rail section. The targeting element 14 is at a distance s from the second detent 19. The alignment aperture 12 is conical in shape such that the alignment aperture widens from the input side 20 of the laser light beam towards the exit side 21 at an angle, which in the example is approx. 45°. The alignment aperture 12 has a diameter d on the input side 21 in the order of magnitude of approx. 1 mm.

According to one embodiment of the invention the alignment of the laser light can also be performed such that no more than one alignment appliance is necessarily needed. In this case an alignment appliance (10 or 11) corresponding to what is described earlier in this application, and which contains an alignment aperture 12, is fixed in a detachable manner to the lower guide rail section that is already installed and aligned. The alignment aperture settles in the lateral direction a pre-defined fixed distance s from the guide rail section in question. A laser 6, which by means of a support element settles in the lateral direction a pre-defined fixed distance s from the guide rail section, is fixed to the same lower guide rail section that is already installed and aligned at a distance below the alignment appliance 10 such that the light source of the laser light beam 7 produced by the laser 6 is at the lateral distance s from the guide rail section, to which guide rail section the laser is fixed. In this case the laser light can be guided to pass through the alignment aperture of the alignment appliance, in which case the laser light beam passing through the alignment aperture is automatically in alignment with the guide rail section, because the light source and the alignment aperture are at the same distance in the lateral direction from the guide rail section. The guide rail section to be installed next as an extension of the aforementioned lower guide rail section that is already aligned is positioned and fixed with one of the methods presented earlier in this application. Thus a targeting appliance 13, which contains a targeting element 14, which when fixing the targeting appliance 13 to the guide rail section settles in the lateral direction the same pre-defined fixed distance s from the guide rail section to be installed as the alignment apertures 12, is detachably fixed to the next guide rail section to be installed. The position of the guide rail section to be installed is adjusted in the lateral direction such that the laser light beam 7 hits the targeting element 14 of the targeting appliance 13, is held in place in this position and fixed to the guide rail fixing 5. In this embodiment the laser is fixed to the lower guide rail section that is already installed via the support element fixed to the laser. The support element can be formed e.g. to possess a similar structure to the detent of the alignment appliance 10 or 11, in which case the support element is preferably formed to possess at least two detents, which rest on the guide rail from different directions and preferably at least one of which magnetically attracts the support element against the guide rail. Alternatively the support element of the laser can be fixed to the guide rail with tightening screws.

Preferably the method and the system are used in the installation of the guide rails 1 of an elevator in high-rise tower buildings, but are just as usable in ordinary apartment blocks. It is also advantageous to use the method and the system in the so-called jump lift installation of the guide rails 1 of an elevator, in which case the guide rail sections are installed from the bottom upwards using the elevator itself, the elevator machine and the elevator car as an aid and the roping of the elevator car is moved upwards in jumps of one or more floors of the building.

It is obvious to the person skilled in the art that the invention is not limited to the embodiments described above, in which the invention is described using examples, but that many adaptations and different embodiments of the invention are possible within the scope of the inventive concept defined by the claims presented below.

1. Method for installing the guide rails of an elevator, such as the car guide rails and/or the counterweight guide rails, on the vertical wall of the elevator shaft of a building, in which method the guide rail is installed by assembly in phases from the bottom upwards by placing guide rail sections that are shorter than the whole length of the guide rail one on top of the other, and by fixing the guide rail sections to the vertical wall, wherein the alignment of each lower guide rail section that is already installed and fixed to the vertical wall is used as a comparison point for the alignment of the next upper guide rail section to be installed above it, such that each upper guide rail section is installed in alignment with each consecutive lower guide rail section.

2. Method according to claim 1 wherein the guide rail sections are aligned by means of a laser light beam produced by a laser.

3. Method according to claim 1, wherein the lowermost guide rail section, which must be installed first, of the guide rail is aligned and installed to be perpendicular by means of a plumb line and/or a perpendicularly aimed laser light beam.

4. Method according to claim 1, wherein
two alignment appliances, a lower alignment appliance and an upper alignment appliance, are fixed in a detachable manner to the lower guide rail section that is already installed and aligned at a distance from each other in the height direction, which alignment appliances each contain an alignment aperture, which when fixing the alignment appliance to the guide rail section settles in the lateral direction a pre-defined fixed distance (s) from the guide rail section,
a laser is fixed in a detachable manner in the proximity of the lower guide rail section at a distance below the lower alignment appliance,
the laser light beam of the laser is directed through the alignment apertures of the lower alignment appliance and the upper alignment appliance, in which case the laser light beam settles in alignment with the lower guide rail,
a targeting appliance, which contains a targeting element, which when fixing the targeting appliance to the guide rail section settles in the transverse direction of the guide rail the aforementioned pre-defined fixed distance (s) from the guide rail section, is fixed in a detachable manner in the proximity of at least one guide rail fixing of the upper guide rail section to be next installed,
the upper guide rail section to be installed is moved in the lateral direction such that the laser light beam hits the targeting element of the targeting appliance, in which position the upper guide rail is held in place, and
the upper guide rail section is fixed to the guide rail fixing.

5. Method according to claim 1, wherein
at least one alignment appliance is fixed in a detachable manner to the lower guide rail section that is already installed and aligned, which alignment appliance contains an alignment aperture, which when fixing the alignment appliance to the guide rail section settles in the lateral direction a pre-defined fixed distance (s) from the guide rail section,
a laser, which settles in the lateral direction a pre-defined fixed distance (s) from the guide rail section, is fixed in a detachable manner to the lower guide rail section at a distance below the alignment appliance,
the laser light beam of the laser is directed through the alignment aperture of the alignment appliance, in which case the laser light beam settles in alignment with the lower guide rail,
a targeting appliance, which contains a targeting element, which when fixing the targeting appliance to the guide rail section settles in the transverse direction of the guide rail the aforementioned pre-defined fixed distance (s) from the guide rail section, is fixed in a detachable manner in the proximity of at least one guide rail fixing of the upper guide rail section to be next installed,
the upper guide rail section to be installed is moved in the lateral direction such that the laser light beam hits the targeting element of the targeting appliance, in which position the guide rail is held in place, and
the upper guide rail section is fixed to the guide rail fixing.

6. Method according to claim 4, wherein during the alignment the targeting appliance is moved in upwards in phases and the targeting appliance is fixed in two or more different points one above the other along the length of the upper guide rail section, preferably in the proximity of two or more guide rail fixings that fix the guide rail section to the vertical wall.

7. Method according to claim 4, wherein a laser light beam, the diameter (D) of which is greater than the diameter (d) of the alignment aperture, is aimed at the alignment appliance, in which case the alignment aperture narrows the laser light beam.

8. Method according to claim 7, wherein the diameter of the laser light beam is narrowed with the alignment aperture to approx. 1 mm.

9. System for installing the guide rails of an elevator, such as the car guide rails and/or the counterweight guide rails, on the vertical wall of the elevator shaft of a building, from guide rail sections one on top of the other that are shorter than the whole length of the guide rail, which guide rail sections are fixed to the vertical wall with guide rail fixings, that wherein the system comprises means for using the alignment of each lower guide rail section that is already installed and fixed as a comparison point for the alignment of the next upper guide rail section to be installed above it, such that each upper guide rail section is installed in alignment with each consecutive lower guide rail section that is already installed.

10. System according to claim 9, wherein the means comprise
a laser, which produces a laser light beam for aligning the guide rail section,
a support element for supporting the laser on the vertical wall and/or on the guide rail section and/or on the guide rail fixing,
at least one, preferably two, of the kind of alignment which comprises a first fixing element, such as a permanent magnet, for fixing the guide rail section, a first detent for positioning the alignment appliance into a precise position with respect to the guide rail section, and an alignment aperture, the diameter (d) of which is at least as great as and preferably smaller than the diameter (D) of the laser light beam and which is at a distance (s) from the first detent, and
a targeting appliance, which comprises a second fixing element, such as a permanent magnet, for fixing the guide rail section, a second detent for positioning the targeting appliance into a precise position with respect to the guide rail section, and a targeting element, which is at a distance (s) from the second detent and at which the laser light beam can be targeted.

11. System according to claim 10, wherein the diameter of the laser light beam produced by the laser is in the order of magnitude of approx. 3 mm.

12. System according to claim 10, wherein the alignment aperture is conical in shape such that the alignment aperture widens from the input side of the laser light beam towards the exit side at an angle, which is approx. 45°.

13. System according to claim 12, wherein the alignment aperture has a diameter (d) on the input side in the order of magnitude of approx. 1 mm.

14. Use of the system according to claim 9 in the installation of the guide rails of an elevator in the elevator shaft of a tower building.

15. Use of the system according to claim 9 in the so-called jump lift installation of the guide rails of an elevator, in which the guide rail sections are installed using the elevator as an aid and the roping of the elevator car is moved upwards in jumps of one or more floors of the building.

16. Method according to claim 2, wherein the lowermost guide rail section, which must be installed first, of the guide rail is aligned and installed to be perpendicular by means of a plumb line and/or a perpendicularly aimed laser light beam.

17. Method according to claim 2, wherein
two alignment appliances, a lower alignment appliance and an upper alignment appliance, are fixed in a detachable manner to the lower guide rail section that is already installed and aligned at a distance from each other in the height direction, which alignment appliances each contain an alignment aperture, which when fixing the alignment appliance to the guide rail section settles in the lateral direction a pre-defined fixed distance (s) from the guide rail section,
a laser is fixed in a detachable manner in the proximity of the lower guide rail section at a distance below the lower alignment appliance,
the laser light beam of the laser is directed through the alignment apertures of the lower alignment appliance and the upper alignment appliance, in which case the laser light beam settles in alignment with the lower guide rail,
a targeting appliance, which contains a targeting element, which when fixing the targeting appliance to the guide rail section settles in the transverse direction of the guide rail the aforementioned pre-defined fixed distance (s) from the guide rail section, is fixed in a detachable manner in the proximity of at least one guide rail fixing of the upper guide rail section to be next installed,
the upper guide rail section to be installed is moved in the lateral direction such that the laser light beam hits the targeting element of the targeting appliance, in which position the upper guide rail is held in place, and
the upper guide rail section is fixed to the guide rail fixing.

18. Method according to claim 3, wherein
two alignment appliances, a lower alignment appliance and an upper alignment appliance, are fixed in a detachable manner to the lower guide rail section that is already installed and aligned at a distance from each other in the height direction, which alignment appliances each contain an alignment aperture, which when fixing the alignment appliance to the guide rail section settles in the lateral direction a pre-defined fixed distance (s) from the guide rail section,
a laser is fixed in a detachable manner in the proximity of the lower guide rail section at a distance below the lower alignment appliance,
the laser light beam of the laser is directed through the alignment apertures of the lower alignment appliance and the upper alignment appliance, in which case the laser light beam settles in alignment with the lower guide rail,
a targeting appliance, which contains a targeting element, which when fixing the targeting appliance to the guide rail section settles in the transverse direction of the guide rail the aforementioned pre-defined fixed distance (s) from the guide rail section, is fixed in a detachable manner in the proximity of at least one guide rail fixing of the upper guide rail section to be next installed,
the upper guide rail section to be installed is moved in the lateral direction such that the laser light beam hits the targeting element of the targeting appliance, in which position the upper guide rail is held in place, and
the upper guide rail section is fixed to the guide rail fixing.

19. Method according to claim 2, wherein
at least one alignment appliance is fixed in a detachable manner to the lower guide rail section that is already installed and aligned, which alignment appliance contains an alignment aperture, which when fixing the alignment appliance to the guide rail section settles in the lateral direction a pre-defined fixed distance (s) from the guide rail section,
a laser, which settles in the lateral direction a pre-defined fixed distance (s) from the guide rail section, is fixed in a detachable manner to the lower guide rail section at a distance below the alignment appliance,
the laser light beam of the laser is directed through the alignment aperture of the alignment appliance in which case the laser light beam settles in alignment with the lower guide rail,
a targeting appliance, which contains a targeting element, which when fixing the targeting appliance to the guide rail section settles in the transverse direction of the guide rail the aforementioned pre-defined fixed distance (s) from the guide rail section, is fixed in a detachable manner in the proximity of at least one guide rail fixing of the upper guide rail section to be next installed,
the upper guide rail section to be installed is moved in the lateral direction such that the laser light beam hits the targeting element of the targeting appliance, in which position the guide rail is held in place, and
the upper guide rail section is fixed to the guide rail fixing.

20. Method according to claim 3, wherein
at least one alignment appliance is fixed in a detachable manner to the lower guide rail section that is already installed and aligned, which alignment appliance contains an alignment aperture, which when fixing the alignment appliance to the guide rail section settles in the lateral direction a pre-defined fixed distance (s) from the guide rail section,
a laser, which settles in the lateral direction a pre-defined fixed distance (s) from the guide rail section, is fixed in a detachable manner to the lower guide rail section at a distance below the alignment appliance,
the laser light beam of the laser is directed through the alignment aperture of the alignment appliance in which case the laser light beam settles in alignment with the lower guide rail,
a targeting appliance, which contains a targeting element, which when fixing the targeting appliance to the guide rail section settles in the transverse direction of the guide rail the aforementioned pre-defined fixed distance (s) from the guide rail section, is fixed in a detachable manner in the proximity of at least one guide rail fixing of the upper guide rail section to be next installed,
the upper guide rail section to be installed is moved in the lateral direction such that the laser light beam hits the targeting element of the targeting appliance, in which position the guide rail is held in place, and
the upper guide rail section is fixed to the guide rail fixing.
